(19) United States
(12) Patent Application Publication
(10) Pub. No.: US 2025/0245341 A1
(43) Pub. Date: Jul. 31, 2025

(54) AUTOMATATED APPLICATION VULNERABILITY TRIAGE MANAGEMENT

(71) Applicant: Salesforce, Inc., San Francisco, CA (US)

(72) Inventors: Manish Malik, Bangalore (IN); Karthikeyan Subramanian, Bangalore (IN); Jai Krishna Ravi, Bangalore (IN)

(73) Assignee: Salesforce, Inc., San Francisco, CA (US)

(21) Appl. No.: 18/423,246

(22) Filed: Jan. 25, 2024

(51) Int. Cl. G06F 21/57

(52) U.S. Cl. CPC G06F 21/577; G06F 2221/033

(57) ABSTRACT

A method and system for classifying a triage-related message related to a software application security technical problem is provided. A triage-related classification is generated for the triage-related message by applying a processor-implemented machine learning model that has been trained to analyze the text of the triage-related message. The generated triage-related classification is sent to a user for remediating the software application security technical problem.

### TECHNICAL FIELD

Embodiments of the subject matter described herein relate generally to software security vulnerability and more particularly to embodiments of the subject matter related to systems and methods for software security vulnerability remediation.

### BACKGROUND

Third party software products are part of risk reduction efforts for a software development organization. It involves examining and securing the software supply chain (e.g., third party software products) that are depended on by software developers to build software for their organization. Third party product dependencies can constitute a large proportion of shipped software in software development. For example, thousands and even millions of third party product components with thousands of unique components can present a significant vulnerability software risk to a software development organization.

To confront the risk, the third party products are assessed with respect to possible vulnerabilities. Identified vulnerabilities are reported and analyzed for vulnerability remediation. Vulnerability remediation actions can take many forms, such as upgrading to a newer version of the third party product which does not have the vulnerability. Security engineering teams endeavor to reduce the risk associated with using third party software products in the minimum time possible. Accordingly, there is a need in the art for methods and systems for providing software security vulnerability remediation.

### BRIEF DESCRIPTION OF THE DRAWINGS

The present disclosure will hereinafter be described in conjunction with the following drawing figures, wherein like numerals denote like elements, and wherein:

FIG. 1 is a block diagram representation of a system that includes a software security triage quality processing system in accordance with at least one embodiment;

FIG. 2 is a flowchart representation of an example method for generating and deploying an AI model for use within a software security triage quality process in accordance with at least one embodiment;

FIG. 3 is a block diagram representation of a system for pre-training a large language model (LLM) in accordance with at least one embodiment;

FIG. 4 is a block diagram representation of a system for training an LLM on a triage note dataset in accordance with at least one embodiment;

FIG. 5 is a block diagram representation of an example of an environment in which an on-demand database service can be used in accordance with some implementations;

FIG. 6 is a block diagram representation of example implementations of elements of FIG. 5 and example interconnections among these elements according to some implementations; and

FIG. 7 is a diagrammatic representation of a machine in an exemplary form of a computer system within which a set of instructions, for causing the machine to perform any one or more of the methodologies discussed herein, may be executed.

### DETAILED DESCRIPTION

A method and system classify a triage-related message related to a software application security technical problem. A triage-related classification is generated for the triage-related message by applying a processor-implemented machine learning model that has been trained to analyze the text of the triage-related message. The generated triage-related classification is sent for remediating the software application security technical problem.

As another example, a processor-implemented method and system classifies a triage-related message related to a software application security technical problem. As an example, one or more data processors of the system store a triage-related message in a non-transitory computer-readable storage medium. The triage-related message is related to an already detected software application security technical problem. The software application security technical problem is to be addressed within a timeframe set by predetermined security severity level criteria. The one or more data processors generate a triage-related classification for the triage-related message by applying a processor-implemented machine learning model that has been trained to analyze the text of the triage-related message with respect to pre-determined approval status classifications. The generated triage-related classification indicates approval status for the triage-related message. The one or more data processors provide the generated triage-related classification for remediating the software application security technical problem within the timeframe set by the predetermined security severity level criteria.

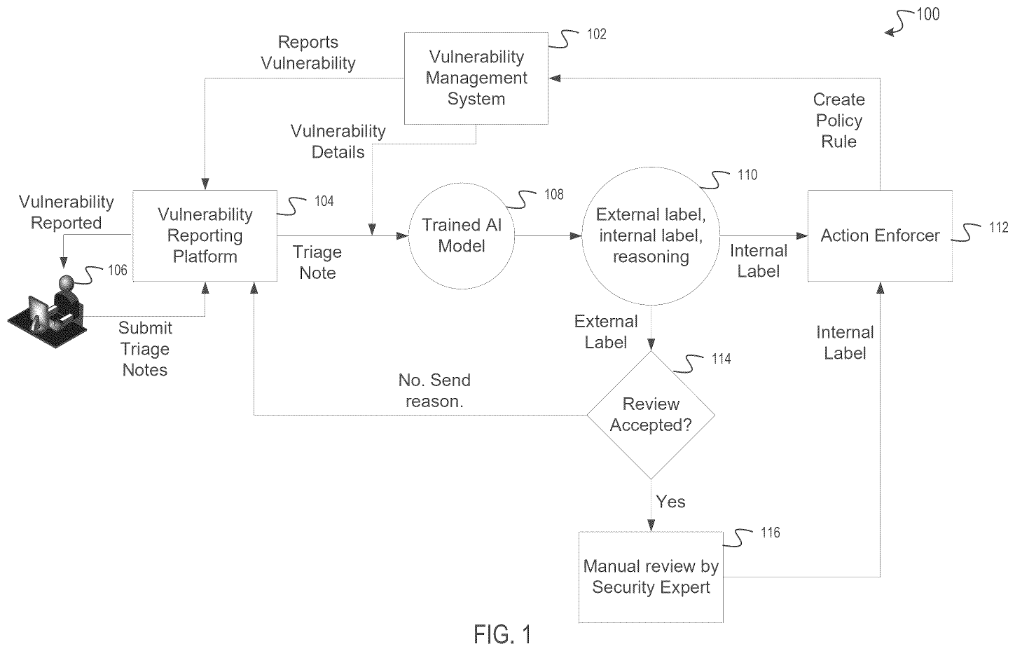

With reference to FIG. 1, a block diagram representation of a system 100 for detecting and remediating third party software product vulnerability is shown. The vulnerability management system 102 automatically scans software images or artifacts contained in a third party software product. Based on the scan results, the vulnerability management system 102 enumerates vulnerabilities in the third party software product artifacts and stores the enumerated vulnerabilities in a vulnerability reporting platform 104.

Examples of software artifacts include certain versioned software artifacts available in docker hub, such as MySQL 5.7 image or certain software artifacts available in maven like spring-boot-starter-web 3.0.12.

In one example embodiment, the vulnerability reporting platform 104 displays software bugs for vulnerabilities in a dashboard or other user interface and has attached a due date for remediation by the software development organization that generated the third party software product. In this example, the vulnerability reporting platform 104 is accessible by the software development organization.

A software development team 106 within the organization accesses information about the reported vulnerabilities through the vulnerability reporting platform 104. The responsibility of remediating a vulnerability typically resides with the software development team 106.

The software development team 106 is to address the reported vulnerability within a specified time. The specified time can be set based upon the situation at hand, such as a specified time provided in a service level agreement (SLA) that is defined by the organization's security policy. An SLA timer is started that counts down the time remaining to fix the vulnerability.

Subsequent to the vulnerability being reported and the SLA timer starting, one or more software developers within the software development team 106 address the reported vulnerability. A developer from the software development team 106 can indicate how the detected vulnerability is to be addressed, such as addressing the vulnerability by pursuing one of the following steps: (1) upgrading to a software fix version; (2) removing the software component if it is un-used or it can be replaced with a software component from another software library; or (3) accessing the dashboard via the vulnerability reporting platform 104 and triaging the vulnerability by providing a textual explanation.

Once the bug is fixed via options 1 or 2, a bug should not show up in subsequent scan results from the vulnerability management system 102. If the software developer pursues option 3, then the vulnerability is triaged, and the SLA time will be extended for a period until the triage period expires. The software developer uses the vulnerability reporting platform 104 to submit triage notes for addressing the vulnerability. The vulnerability reporting platform 104 stores the triage notes submitted by the software development team 106. The stored triage notes containing the textual explanation from the software development team 106 is validated by system 100.

In the validation process, a trained artificial intelligence (AI) model 108 retrieves the triage notes from the vulnerability reporting platform 104 as well as additional details from the vulnerability management system 102. The additional details include the following: current version of the software artifact which is vulnerable, operating systems it is running on, the fix version available for a software artifact (e.g., it can be empty in case no fix version is available), etc. These are the context under which the vulnerability is reported or additional details which will be useful for action enforcer/reasoning. The AI model 108 validates the triage notes and then indicates the action that should be taken with respect to the submitted triage notes.

In an embodiment of the validation process, the AI model 108 generates at 110 two categories of labelling along with substantive reasons for the categorizations: the first category is for the external software development team 106 and the second category is for internal use within the system 100. The first category's external label for the external software developers can include such actions for a submitted triage note as accepted, rejected, need more explanation, etc.

The external label output is used at 114 to determine whether the review should result in the explanation provided in the triage note to be accepted. If the review results in the triage note not being accepted at 114, then the vulnerability reporting platform 104 notifies the software development team 106 that a more detailed or updated reason is needed from them in order for their triage note to be accepted. If the review results in the triage note being accepted at 114, then a security expert performs a manual review at 116. The manual review results in an internal label being sent to the action enforcer 112.

The second category's internal label captures for an action enforcer 112 more detailed information about the triage. The action enforcer 112 can be thought of as a system that converts the reason that was fed into it, to a policy that validates the premise of the reasons. For example, when a triage indicates that the reported vulnerability is not relevant for a Centos Operating System, then the action enforcer can write a policy to ensure that whenever the vulnerability management system 102 discovers the same vulnerability in different environments, the given triage is invalidated for that Operating System.

As an example, an internal label can identify that at the time of triage, no upgradable fix version was available. The identification allows that if a fix version is available at a later time, then the vulnerability management system 102 can invalidate the earlier submitted triage note with a reason such as “the fix version is now available.” Based upon such a message, the software development team 106 can assess again the earlier reported vulnerability in the software component for which a fix version was originally not available.

From both the external label and internal label, the action enforcer 112 generates a policy which is validated by the vulnerability management system 102 whenever the same or similar vulnerability is found again. In this way, the action enforcer 112 utilizes the labels to ensure that appropriate action is taken for the labels generated for the triage by the AI model 108.

It should be understood that additional components can be included that facilitate operation of the system 100.

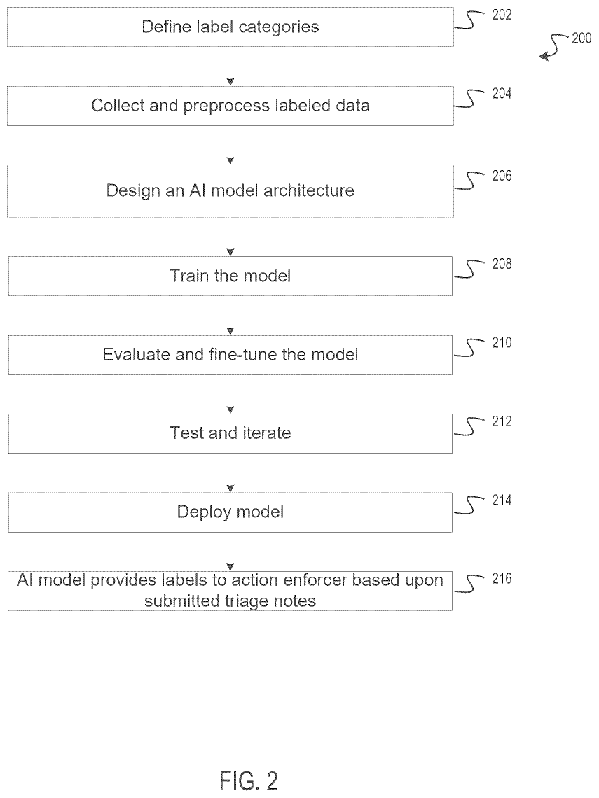

With reference to FIG. 2, a flowchart representation of an example method 200 of generating an AI model (shown at 108 in FIG. 1) for use within a software security triage quality process. The example method 200 in general includes designing an AI model which provides an appropriate decision given a triage note and using an action enforcer for enforcing the decisions given by the AI model. In this example of FIG. 2, an AI model is specially designed to generate categories based upon the text-based and subjective triage notes. The triage explanation is free form text in which the software developer enters a valid triage reason.

Step 202 defines the external and internal label categories that are to be assigned to the text messages. As an example, external labels categories can include the following: ACCEPT_TRIAGE_NOTE, REJECT_TRIAGE_NOTE, and NEED_MORE_EXPLANATION for external use cases. An external label is shared with external software developers for a submitted triage.

The above example external labels are described further below:

(a) ACCEPT_TRIAGE_NOTE: The given triage note is valid and can be accepted. For example, someone may triage a vulnerability as “False” positive because the vulnerable code path is not used. Additionally there may not be an upgradable fix version available at the time of triage. In such a triage, a valid reason for triage is given and also no fix version was available at the time of triage, so it can be accepted as a triage note.

(b) REJECT_TRIAGE_NOTE: This label means that the given triage note is insufficient. For example, if a triage note specifies that “No upgradable fix version available”, but there are a fix version available at the time of triage, then such labels are rejected with that reason. This will be returned to the developer directly with reasoning for rejections such as “Rejected because fix version x.y.z is available for this vulnerability”. So, the developer may need to provide more details why the fix cannot be applied or try the upgrade in case they may have missed that detail at the time of triage.

(c) NEED_MORE_EXPLANATION: This label means more information is needed in the triage note. For example if a triage note may say “need more time” in this message, then the system 1001 is not giving a reason why we needed more time. So, it is labeled NEED_MORE_EXPLANATION to ensure this is not misused.

Internal label categories can include the following: TRIAGED_DUE_TO_NO_UPGRADE, TRIAGED_DUE_TO_DIFFICULT_UPGRADE,

TRIAGED_NEED_MORE_TIME, TRIAGE_NOT_USED and TRIAGE_NOT_APPLICABLE. These categories are used by the action enforcer (in step 214 of FIG. 2). An internal label is not shared with external software developers for a submitted triage.

The above example internals labels are described further below:

(a) TRIAGED_DUE_TO_NO_UPGRADE: A triage note that is labeled as this, indicates that at the time of triage, no upgradable fix version is available. So, at some later stage if the system finds that a fix version is available, then the system can invalidate this triage note with a reason such as “the fix version is now available”.

(b) TRIAGED_NEED_MORE_TIME: This indicates that the reviewer needed more time to apply the fix. If the same team is using this triage note multiple time it may suggest triage misuse.

(c) TRIAGE_NOT_USED: A triage note that says that given components are not used are given such a label. In such cases, if the system detects that the same component is ever used in any project via call graph or other mechanism then the system invalidates the existing triage.

(d) TRIAGE_NOT_APPLICABLE: Sometimes a fix for a vulnerability is difficult to apply due to some complex dependency, but the system may have some mitigations in place to ensure that the vulnerability is not exploitable. Such type of vulnerability may be given some exception in the presence of mitigations. As an example, consider a vulnerability where a possible mitigation could be changing the firewall rule of the host where the application is deployed. So, the exceptions are granted given that the changes have been applied in the firewall rule of host where the application is running. For such type of exceptions, the system can have a policy verifying whether the premise on which an exception is given holds valid throughout the period where exceptions are active.

Step 204 collects and preprocesses a labeled training dataset. The processing includes gathering a dataset of text messages along with their corresponding labels. In this example, an existing LLM model is pre-trained.

Because an AI model is trained to work on triaging reports, step 204 can use a pre-existing triage database for training. Step 204 can export the vulnerability details such as vulnerable version, component name, vulnerability details, etc. This can be available from pre-existing vendor tools that are used for scanning artifacts or can be fetched from NVD directly. The analysis provides understanding with respect to the context on which a given triage was applied. A triage can also be manually annotated with the appropriate label, and if applicable, the reasoning behind it. The reasoning ensures that the trained model provides category predictions backed with substantive reasoning. The triage data can also be pre-processed by removing noise, normalizing text, and handling any other pre-processing steps.

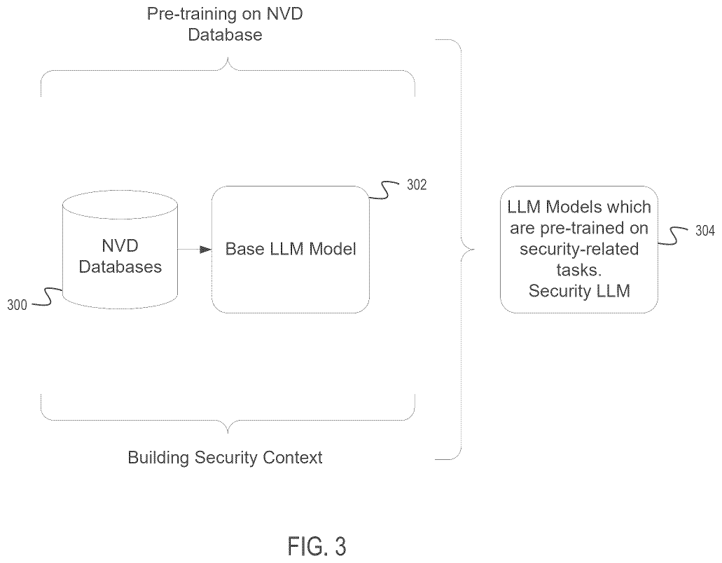

FIG. 3 provides an example of step 204 wherein the National Vulnerability (NVD) databases 300 available from the National Institute of Standards and Technology (NIST) at the U.S. Department of Commerce is used for pre-training and generating a base LLM model 302. For pre-training, step 204 uses the tasks such as predicting Common Vulnerabilities and Exposures (CVE) scores for a given vulnerability in NVD or any other suitable task. This pre-training step helps in building security context at 304 for the base LLM model 302. This can also help in other downstream training tasks related to learning triage notes.

An example of a given vulnerability is the following: “CVE-2023-26464 ** UNSUPPORTED WHEN ASSIGNED When using the Chainsaw or SocketAppender components with Log4j 1.x on JRE less than 1.7, an attacker that manages to cause a logging entry involving a specially-crafted (i.e., deeply nested) hashmap or hashtable (depending on which logging component is in use) to be processed could exhaust the available memory in the virtual machine and achieve Denial of Service when the object is deserialized. This issue affects Apache Log4j before 2. Affected users are recommended to update to Log4j2.x. NOTE: This vulnerability only affects products that are no longer supported by the maintainer.”

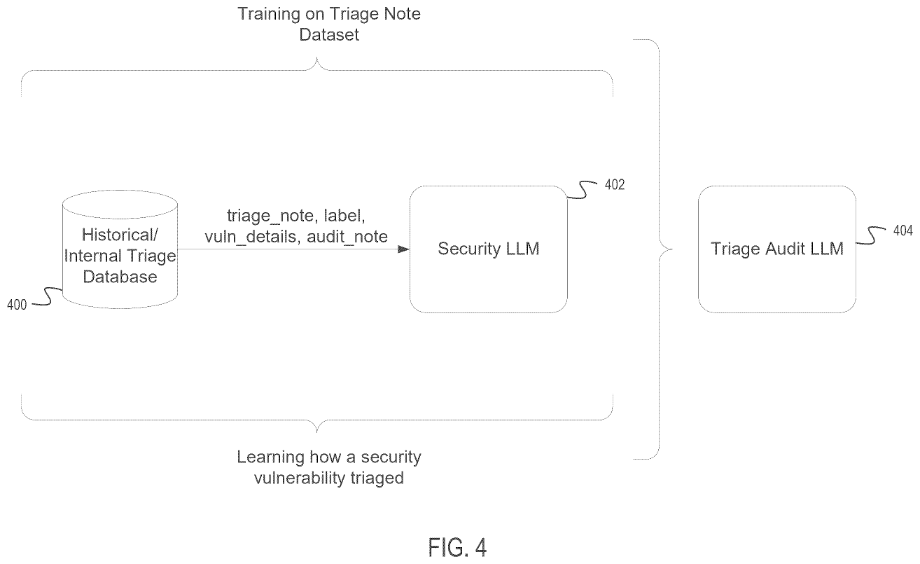

FIG. 4 provides an additional example of processing associated with step 204. In FIG. 4, a security LLM 402 is trained on a pre-existing triage note dataset (e.g., a historical/internal triage database 400). The security LLM 402 is trained to identify how a security vulnerability should be triaged. The training results in a triage audit LLM 404.

Step 206 involves designing an AI model architecture. An AI model architecture is selected for the language model. Transformers, such as GPT (Generative Pre-trained Transformer), can be used for various NLP tasks. Step 206 can also use a pre-trained NLP models based on large language models (LLMs), such as GPT4, LLaMa, etc. The basic requirement is that the system should be able to fine tune it for specific use cases.

Step 208 involves training the model based upon the data generated in the previous steps. For example, the LLM model is trained using the previously generated labeled dataset. During training, the model learns to predict the correct label based on the input text and the associated reasoning. The process typically involves optimizing the model's parameters using techniques such as back-propagation and gradient descent.

Step 210 evaluates and fine-tunes the model. Processing includes assessing the performance of a trained model using evaluation metrics such as accuracy, precision, recall, or F1 score. If the performance is not satisfactory, step 210 may need to fine-tune the model by adjusting hyperparameters, modifying the architecture, or using techniques, such as transfer learning.

Step 212 tests and iterates upon the model. After the model is trained and evaluated, step 212 tests it with new, unseen text messages to ensure it performs well on real-world data. If necessary, step 212 iterates on the model, dataset, or preprocessing steps to improve its performance.

Step 214 deploys the model after step 212′s acceptable testing and iteration processing. The deployed model is used, for example, within system 100 of FIG. 1.

After deployment, an action enforcer in step 216 can generate a policy which is validated whenever the same vulnerability is found again. The validation process for the action enforcer uses both external labels (e.g., ACCEPT_TRIAGE_NOTE) and internal labels. As an example, a policy for TRIAGED_DUE_TO_NO_UPGRADE could check for the availability of a fix version addressing the reported vulnerability. So, whenever the fix version is available, the policy is violated and thereby invalidates the triage note. The policy rule can be created in static manner for each type of labels or can be used as a separate AI model to generate the policy rules.

As additional examples of post-validation processing, there can be oversight by system 100 of FIG. 1 to ensure that the explanation remains valid for the period of an extended SLA. As another example, if at the time of triage, there is no upgradable fix version available but subsequently a fix version is available, system 100 invalidates such triage notes. As another example, the reported vulnerability can be considered as not exploitable since the vulnerable code path is not used anywhere in the projects. While it may be true at the time of submission of the triage note, the vulnerable code path may come into use because the code was rewritten to use it. In such case also, post-validation processing by system 100 invalidates such a triage note.

The deployed AI model is trained to detect whether the triage notes are being misused. More specifically, the AI model provides a technical solution for a supply chain security domain which explicitly targets the abuse of vulnerability triage or exceptions by leveraging the natural language processing (NLP) and adapting such solutions to work in security context or domain knowledge.

As another example, the deployed AI model can support manual or automatic triage-at-intake. This involves a vulnerability that is discovered in a third party product component at the time of “intake” (e.g., at the very first time a third party product component is brought into the system 100 of FIG. 1.

As can be appreciated in light of the disclosure, the order of operation within the method 200 is not limited to the sequential execution as illustrated in FIG. 2 but may be performed in one or more varying orders as applicable and in accordance with the present disclosure.

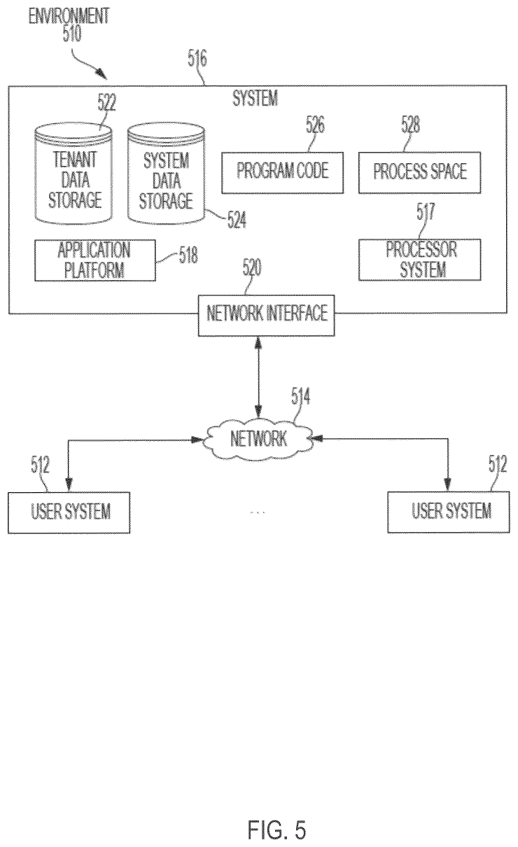

The triaged software components can be used within many different software environments. As an example, FIG. 5 shows a block diagram of an example of an environment 510 in which an on-demand database service can be used with the software triaged in accordance with some implementations of the software triage quality systems and methods disclosed herein.

The environment 510 includes user systems 512 (also referred to a client device), a network 514, a database system 516 (also referred to herein as a “cloud-based system”), a processor system 517, an application platform 518, a network interface 520, tenant database 522 for storing tenant data 523, system database 524 for storing system data 525, program code 526 for implementing various functions of the system 516, and process space 528 for executing database system processes and tenant-specific processes, such as running applications as part of an application hosting service. In some other implementations, environment 510 may not have all of these components or systems, or may have other components or systems instead of, or in addition to, those listed above.

In some implementations, the environment 510 is an environment in which an on-demand database service exists. An on-demand database service, such as that which can be implemented using the system 516, is a service that is made available to users outside of the enterprise(s) that own, maintain or provide access to the system 516. As described above, such users generally do not need to be concerned with building or maintaining the system 516. Instead, resources provided by the system 516 may be available for such users' use when the users need services provided by the system 516; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 518 can be a framework that allows the applications of system 516 to execute, such as the hardware or software infrastructure of the system 516. In some implementations, the application platform 518 enables the creation, management and execution of one or more applications developed by the provider of the on-demand database service, users accessing the on-demand database service via user systems 512, or third-party application users accessing the on-demand database service via user systems 512.

In some implementations, the system 516 implements a web-based customer relationship management (CRM) system. For example, in some such implementations, the system 516 includes application servers configured to implement and execute CRM software applications as well as provide related data, code, forms, renderable webpages and documents and other information to and from user systems 512 and to store to, and retrieve from, a database system related data, objects, and Webpage content. In some MTS implementations, data for multiple tenants may be stored in the same physical database object in tenant database 522. In some such implementations, tenant data is arranged in the storage medium(s) of tenant database 522 so that data of one tenant is kept logically separate from that of other tenants so that one tenant does not have access to another tenant's data, unless such data is expressly shared. The system 516 also implements applications other than, or in addition to, a CRM application. For example, the system 516 can provide tenant access to multiple hosted (standard and custom) applications, including a CRM application. User (or third-party user) applications, which may or may not include CRM, may be supported by the application platform 518. The application platform 518 manages the creation and storage of the applications into one or more database objects and the execution of the applications in one or more virtual machines in the process space of the system 516.

According to some implementations, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 514 can be or include any network or combination of networks of systems or devices that communicate with one another. For example, the network 514 can be or include any one or any combination of a LAN (local area network), WAN (wide area network), telephone network, wireless network, cellular network, point-to-point network, star network, token ring network, hub network, or other appropriate configuration. The network 514 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 512 can communicate with system 516 using TCP/IP and, at a higher network level, other common Internet protocols to communicate, such as HTTP, FTP, AFS, WAP, etc. In an example where HTTP is used, each user system 512 can include an HTTP client commonly referred to as a “web browser” or simply a “browser” for sending and receiving HTTP signals to and from an HTTP server of the system 516. Such an HTTP server can be implemented as the sole network interface 520 between the system 516 and the network 514, but other techniques can be used in addition to or instead of these techniques. In some implementations, the network interface 520 between the system 516 and the network 514 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 512 can be implemented as any computing device(s) or other data processing apparatus or systems usable by users to access the database system 516. For example, any of user systems 512 can be a desktop computer, a workstation, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 512 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 516) of the user system 512 to access, process and view information, pages and applications available to it from the system 516 over the network 514.

Each user system 512 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 512 in conjunction with pages, forms, applications and other information provided by the system 516 or other systems or servers. For example, the user interface device can be used to access data and applications hosted by system 516, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 512 may differ in their respective capacities, and the capacity of a particular user system 512 can be entirely determined by permissions (permission levels) for the current user of such user system. For example, where a salesperson is using a particular user system 512 to interact with the system 516, that user system can have the capacities allotted to the salesperson. However, while an administrator is using that user system 512 to interact with the system 516, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 512 and some or all of its components are operator-configurable using applications, such as a browser, including computer code executed using a central processing unit (CPU) such as an Intel Pentium® processor or the like. Similarly, the system 516 (and additional instances of an MTS, where more than one is present) and all of its components can be operator-configurable using application(s) including computer code to run using the processor system 517, which may be implemented to include a CPU, which may include an Intel Pentium® processor or the like, or multiple CPUs.

The system 516 includes tangible computer-readable media having non-transitory instructions stored thereon/in that are executable by or used to program a server or other computing system (or collection of such servers or computing systems) to perform some of the implementation of processes described herein. For example, computer program code 526 can implement instructions for operating and configuring the system 516 to intercommunicate and to process webpages, applications and other data and media content as described herein. In some implementations, the computer code 526 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, JAVA®, JAVASCRIPT®, ActiveX®, any other scripting language, such as VBScript®, and many other programming languages as are well known may be used. (JAVA™ is a trademark of Sun Microsystems, Inc.).

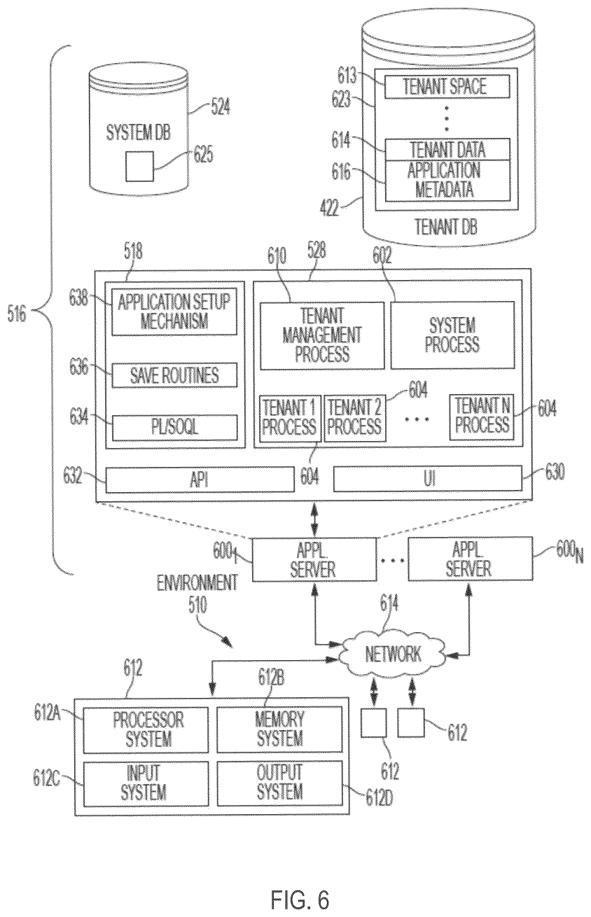

FIG. 6 shows a block diagram of example implementations of elements in FIG. 5 and example interconnections between these elements according to some implementations. That is, FIG. 6 also illustrates environment 510, but FIG. 6, various elements of the system 516 and various interconnections between such elements are shown with more specificity according to some more specific implementations. Elements from FIG. 6 that are also shown in FIG. 5 will use the same reference numbers in FIG. 6 as were used in FIG. 5. Additionally, in FIG. 6, the user system 612 includes a processor system 612A, a memory system 612B, an input system 612C, and an output system 612D. The processor system 612A can include any suitable combination of one or more processors. The memory system 612B can include any suitable combination of one or more memory devices. The input system 612C can include any suitable combination of input devices, such as one or more touchscreen interfaces, keyboards, mice, trackballs, scanners, cameras, or interfaces to networks. The output system 612D can include any suitable combination of output devices, such as one or more display devices, printers, or interfaces to networks.

In FIG. 6, the network interface 520 of FIG. 5 is implemented as a set of HTTP application servers 6001-600N. Each application server 600, also referred to herein as an “app server,” is configured to communicate with tenant database 522 and the tenant data 623 therein, as well as system database 524 and the system data 625 therein, to serve requests received from the user systems 612. The tenant data 623 can be divided into individual tenant storage spaces 613, which can be physically or logically arranged or divided. Within each tenant storage space 613, tenant data 614 and application metadata 616 can similarly be allocated for each user. For example, a copy of a user's most recently used (MRU) items can be stored to tenant data 614. Similarly, a copy of MRU items for an entire organization that is a tenant can be stored to tenant storage space 613.

The process space 528 includes system process space 602, individual tenant process spaces 604 and a tenant management process space 610. The application platform 518 includes an application setup mechanism 638 that supports application users' creation and management of applications. Such applications and others can be saved as metadata into tenant database 522 by save routines 636 for execution by subscribers as one or more tenant process spaces 604 managed by tenant management process 610, for example. Invocations to such applications can be coded using PL/SOQL 634, which provides a programming language style interface extension to API 632. Invocations to applications can be detected by one or more system processes, which manage retrieving application metadata 616 for the subscriber making the invocation and executing the metadata as an application in a virtual machine.

The system 516 of FIG. 6 also includes a user interface (UI) 630 and an application programming interface (API) 632 to system 516 resident processes to users or users at user systems 612. In some other implementations, the environment 510 may not have the same elements as those listed above or may have other elements instead of, or in addition to, those listed above.

Each application server 600 can be communicably coupled with tenant database 522 and system database 524, for example, having access to tenant data 623 and system data 625, respectively, via a different network connection. For example, one application server 6001 can be coupled via the network 514 (for example, the Internet), another application server 600N can be coupled via a direct network link, and another application server (not illustrated) can be coupled by yet a different network connection. Transfer Control Protocol and Internet Protocol (TCP/IP) are examples of typical protocols that can be used for communicating between application servers 600 and the system 516. However, it will be apparent to one skilled in the art that other transport protocols can be used to optimize the system 516 depending on the network interconnections used.

In some implementations, each application server 600 is configured to handle requests for any user associated with any organization that is a tenant of the system 516. Because it can be desirable to be able to add and remove application servers 600 from the server pool at any time and for various reasons, in some implementations there is no server affinity for a user or organization to a specific application server 600. In some such implementations, an interface system implementing a load balancing function (for example, an F5 Big-IP load balancer) is communicably coupled between the application servers 600 and the user systems 612 to distribute requests to the application servers 600. In one implementation, the load balancer uses a least-connections algorithm to route user requests to the application servers 600. Other examples of load balancing algorithms, such as round robin and observed-response-time, also can be used. For example, in some instances, three consecutive requests from the same user could hit three different application servers 600, and three requests from different users could hit the same application server 600. In this manner, by way of example, system 516 can be a multi-tenant system in which system 516 handles storage of, and access to, different objects, data and applications across disparate users and organizations.

In one example storage use case, one tenant can be a company that employs a sales force where each salesperson uses system 516 to manage aspects of their sales. A user can maintain contact data, leads data, customer follow-up data, performance data, goals and progress data, etc., all applicable to that user's personal sales process (for example, in tenant database 522). In an example of an MTS arrangement, because all of the data and the applications to access, view, modify, report, transmit, calculate, etc., can be maintained and accessed by a user system 612 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 516 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 516 also can maintain system level data usable by multiple tenants or other data. Such system level data can include industry reports, news, postings, and the like that are sharable among tenants.

In some implementations, the user systems 612 (which also can be client systems) communicate with the application servers 600 to request and update system-level and tenant-level data from the system 516. Such requests and updates can involve sending one or more queries to tenant database 522 or system database 524. The system 516 (for example, an application server 600 in the system 516) can automatically generate one or more SQL statements (for example, one or more SQL queries) designed to access the desired information. System database 524 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

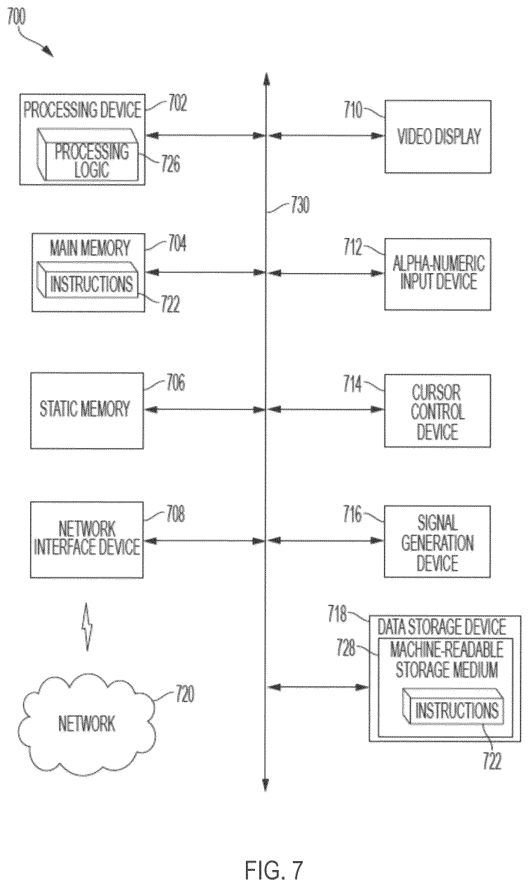

FIG. 7 illustrates a diagrammatic representation of a machine in the exemplary form of a computer system 700 within which a set of instructions for causing the machine to perform any one or more of the methodologies discussed herein, may be executed. The system 700 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a user system, a client device, or a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In at least one embodiment, computer system 700 may represent, for example, elements of the cloud-based computing platform or any other elements of FIG. 1 (e.g. clients, computing systems used by the customers 150, the third-party application exchange 160) or any elements of FIGS. 7 through 5, etc.

The exemplary computer system 700 includes a processing device (processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 718, which communicate with each other via a bus 730.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a computer-readable medium 728 on which is stored one or more sets of instructions 722 (e.g., instructions of in-memory buffer service 94) embodying any one or more of the methodologies or functions described herein. The instructions 722 may also reside, completely or at least partially, within the main memory 704 and/or within processing logic 726 of the processing device 702 during execution thereof by the computer system 700, the main memory 704 and the processing device 702 also constituting computer-readable media. The instructions may further be transmitted or received over a network 720 via the network interface device 708.

While the computer-readable storage medium 728 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor,” “processor system,” or “processing system” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general-purpose digital computer, by using a special-purpose computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, at least one embodiment of a system or a component may employ various integrated circuit components, e.g., memory elements, digital signal processing elements, logic elements, look-up tables, or the like, which may carry out a variety of functions under the control of one or more microprocessors or other control devices.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “determining,” “analyzing,” “identifying,” “adding,” “displaying,” “generating,” “querying,” “creating,” “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

Any suitable programming language can be used to implement the routines of particular embodiments including C, C++, JAVA®, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one example embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those of ordinary skill in the art with a convenient road map for implementing the described embodiments. It should be understood that various changes can be made in the function and arrangement of elements without departing from the scope defined by the claims, which includes known equivalents and foreseeable equivalents at the time of filing this patent application.

What is claimed is:

1. A processor-implemented method for classifying a triage-related message related to a software application security technical problem, said method comprising:
storing, by one or more data processors, the triage-related message in a non-transitory computer-readable storage medium;
wherein the triage-related message is related to an already detected software application security technical problem;
wherein the software application security technical problem is to be addressed within a timeframe set by predetermined security severity level criteria;
generating, by the one or more data processors, a triage-related classification for the triage-related message by applying a processor-implemented machine learning model that has been trained to analyze the text of the triage-related message with respect to pre-determined approval status classifications;
wherein the generated triage-related classification indicates approval status for the triage-related message; and
sending, by the one or more data processors, the generated triage-related classification to a user for remediating the software application security technical problem within the timeframe set by the predetermined security severity level criteria.

2. The method of claim 1, wherein an already detected software application security technical problem includes automatically scanning software images or artifacts contained in a third party software product.

3. The method of claim 2, further comprising enumerating vulnerabilities in the third party software product artifacts based on the scanned software images or artifacts.

4. The method of claim 1, wherein the software application security technical problem to be addressed within a timeframe further comprising setting the timeframe based upon a service level agreement defined by the organization's security policy.

5. The method of claim 4, further comprising starting the service level agreement timer that counts down time remaining to fix the vulnerability.

6. The method of claim 1, further comprising indicating by a software development team through a vulnerability reporting system how the detected vulnerability is to be addressed.

7. The method of claim 1, wherein the detected vulnerability being addressed includes accessing a dashboard through the vulnerability reporting platform and triaging the vulnerability by providing a textual explanation.

8. The method of claim 1, wherein the triaging the vulnerability by providing the textual explanation includes extending the service level agreement time for a period until a prespecified triage period expires.

9. The method of claim 1, wherein the textual explanation from the software development team 106 is validated by the processor-implemented machine learning model.

10. The method of claim 9, wherein the processor-implemented machine learning model includes a large language model (LLMs) or GPT4 model or LlaMa model for generating an internal classification category and an external classification category.

11. A system for classifying a triage-related message related to a software application security technical problem, the system comprising:
at least one or more processors; and
at least one non-transitory machine-readable storage medium that stores instructions configurable to be executed by the at least one processor to:
store, by the one or more data processors, the triage-related message in a non-transitory computer-readable storage medium;
wherein the triage-related message is related to an already detected software application security technical problem;
wherein the software application security technical problem is to be addressed within a timeframe set by predetermined security severity level criteria;
generate, by the one or more data processors, a triage-related classification for the triage-related message by applying a processor-implemented machine learning model that has been trained to analyze the text of the triage-related message with respect to pre-determined approval status classifications;
wherein the generated triage-related classification indicates approval status for the triage-related message; and
send, by the one or more data processors, the generated triage-related classification to a user for remediating the software application security technical problem within the timeframe set by the predetermined security severity level criteria.

12. The system of claim 11, wherein an already detected software application security technical problem includes automatically scanning software images or artifacts contained in a third party software product.

13. The system of claim 12, further comprising enumerating vulnerabilities in the third party software product artifacts based on the scanned software images or artifacts.

14. The system of claim 11, wherein the software application security technical problem to be addressed within a timeframe further comprising setting the timeframe based upon a service level agreement defined by the organization's security policy.

15. The system of claim 14, further comprising starting the service level agreement timer that counts down time remaining to fix the vulnerability.

16. The system of claim 11, further comprising indicating by a software development team through a vulnerability reporting system how the detected vulnerability is to be addressed.

17. The system of claim 11, wherein the detected vulnerability being addressed includes accessing a dashboard through the vulnerability reporting platform and triaging the vulnerability by providing a textual explanation.

18. The system of claim 11, wherein the triaging the vulnerability by providing the textual explanation includes extending the service level agreement time for a period until a prespecified triage period expires.

19. The system of claim 11, wherein the textual explanation from the software development team 106 is validated by the processor-implemented machine learning model;
wherein the processor-implemented machine learning model includes a large language model (LLMs) or GPT4 model or LlaMa model for generating an internal classification category and an external classification category.

20. A non-transitory machine-readable storage medium that stores instructions executable by at least one or more processors, the instructions configurable to cause the at least one processor to perform operations comprising:
storing, by the one or more data processors, the triage-related message in a non-transitory computer-readable storage medium;
wherein the triage-related message is related to an already detected software application security technical problem;
wherein the software application security technical problem is to be addressed within a timeframe set by predetermined security severity level criteria;
generating, by the one or more data processors, a triage-related classification for the triage-related message by applying a processor-implemented machine learning model that has been trained to analyze the text of the triage-related message with respect to pre-determined approval status classifications;
wherein the generated triage-related classification indicates approval status for the triage-related message; and
sending, by the one or more data processors, the generated triage-related classification to a user for remediating the software application security technical problem within the timeframe set by the predetermined security severity level criteria.
